(19) United States
(12) Patent Application Publication
(10) Pub. No.: US 2026/0288626 A1
(43) Pub. Date: Sep. 24, 2026

(54) UNSUPERVISED AUTOMATED USER INTERFACE TESTING

(71) Applicant: OPEN TEXT HOLDINGS, INC., Menlo Park, CA (US)

(72) Inventor: Avishek Kumar Shaw, Baidyabati (IN)

(21) Appl. No.: 19/085,685

(22) Filed: Mar. 20, 2025

(51) Int. Cl. G06F 11/3668; G06F 11/3698

(52) U.S. Cl. CPC G06F 11/3688; G06F 11/3698

(57) ABSTRACT

Systems and methods for unsupervised user interface testing are provided. Various embodiments of the present technology provide systems and methods for improved user interface testing that will help in verifying that a product's user interface is displayed correctly to all users across different browsers and devices. In some embodiments, an algorithm checks for general pixel differences between a user interface (UI) screenshot and an expected UI and uses a correlation coefficient algorithm to see how similar the two images are at a basic pixel level. If the images are very similar at this stage, the test passes. If this check fails, the algorithm then looks at the markup variations and determines a pass or fail result. If the markup variation check also fails, the algorithm proceeds to check the overall layout variation between the two images. The algorithm ultimately gives an output of “passed” or “failed” based on the process.

### TECHNICAL FIELD

This disclosure relates generally to user interface (UI) testing. In particular, this disclosure relates to systems and methods for unsupervised automated UI testing, and in more particular, to systems and methods for unsupervised automated UI testing that use algorithms to automatically compare expected and actual rendered user interfaces using a combination of image processing techniques.

### BACKGROUND

Current methods for ensuring the quality and consistency of software user interfaces (UIs) often rely heavily on manual testing, where a person visually compares a captured screenshot of the actual UI against an expected UI screenshot. While a human tester can efficiently identify discrepancies, this process is cumbersome, time-consuming, and prone to errors, especially when dealing with fine-grained differences or subtle layout shifts that can be easily overlooked. Furthermore, manual testing can be expensive and may not be feasible to perform exhaustively across all the different browsers and devices on which a product might be used.

To address these limitations, some attempts have been made to automate UI testing. However, existing automated solutions often fall short. For instance, simply comparing images at a pixel level can lead to a high number of false failures because legitimate variations in markup or layout can cause pixel differences, even when the UI is functionally correct. These simplistic pixel comparison methods do not provide detailed information about the nature of the failure (e.g., color, markup, content, or layout), making it difficult for developers to identify and fix the underlying issues without resorting back to manual inspection. Some automated approaches might attempt rely on machine learning (ML) models, which, even if they were effective, would require significant amounts of resources to train, and significant amounts of training data encompassing various scenarios. Moreover, a machine learning-based solutions would also require more computational resources.

Therefore, there is a clear need for an improved automated UI testing solution that can accurately and efficiently identify discrepancies beyond basic pixel differences, can operate without the need for extensive manual training data, and can provide specific feedback regarding the type of visual deviation (such as pixel, markup, layout, color, fine-grained, or content variations) to streamline the debugging and quality assurance processes. Such a solution would significantly enhance the productivity of development and testing teams, improve the overall quality of software products, and ensure a consistent user experience across diverse platforms and devices.

### SUMMARY

Systems and methods for unsupervised user interface testing are described that, in some embodiments, include receiving an input image, the input image comprising a screenshot of a UI output being tested and pre-processing the input image by scaling and normalizing the input image. A degree of pixel variation is identified between the input image and an expected UI output image using a correlation coefficient algorithm that generates a pixel variation score relating to a degree of pixel variation between the input image and the expected UI output image. A pass or fail result of the identified pixel variation is generated based on the pixel variation matching score. Responsive to a failed result of identified pixel variation, a markup variation identification is performed between the input image and the expected UI output image to identify a markup and to determine a markup variation score relating to a degree of markup variation between the input image and the expected UI output image. Responsive to a failed result of markup variation, a layout variation identification is performed between the input image and the expected UI output image using a second correlation coefficient algorithm that generates a layout variation score relating to a degree of layout variation between the input image and the expected UI output image. Finally a test result is provided indicating whether the input image meets expectations.

In some embodiments, the markup variation identification includes generating a matching score by applying a correlation coefficient algorithm to a labeled image based on identified objects in the input image and the expected UI output image, identifying matching edges of markups identified in the input image and the expected UI output image, and wherein the markup variation score is determined by combining the matching score and the matching edges. In some embodiments, generating the matching score includes generating a gray-scale image from the input image, filtering the gray-scale image to remove noise, wherein the objects identified in the image are identified using a connected component algorithm, and wherein the generating labeled image is generated based on the identified objects in the image and a threshold value. In some embodiments, identifying matching edges includes Identifying edges around the identified markup in the input image and the expected UI output image.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 illustrates an exemplary user interface test focusing on fine-grained visual differences.

FIG. 2 illustrates an exemplary user interface test focusing on fine-grained visual differences.

FIG. 3 illustrates an exemplary user interface test focusing on color variations.

FIG. 4 illustrates an exemplary user interface test focusing on markup variation.

FIG. 5 illustrates an exemplary user interface test focusing on markup variation.

FIG. 6 illustrates an exemplary user interface test specifically examining content differences.

FIG. 7 illustrates an exemplary user interface test specifically examining content differences.

FIG. 8 illustrates an exemplary user interface test focusing on layout comparison.

FIG. 9 is a block diagram illustrating an exemplary operation for an automated user interface testing system.

FIG. 10 is a diagram showing a process of generating a labeled image from an expected input image.

FIG. 11 is a diagram showing a process of generating a labeled image from a test input image.

FIG. 12 illustrates a process for matching edges for a markup variation process.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method that provides unsupervised automated user interface testing algorithms that will help in verifying that a product's user interface is displayed correctly to all users across different browsers and devices. Generally, the disclosed automated user interface testing system works by automatically comparing how a UI is expected to look with how it actually looks. The system does this by taking two screenshots as inputs: the expected UI screenshot and the actual UI screenshot. The algorithm then goes through a series of checks (described in detail below) to see if they match. Following is a brief description of an exemplary process. More detailed descriptions follow.

In some embodiments, the algorithm first checks for general pixel differences (pixel variation identification). The algorithm uses a correlation coefficient algorithm to see how similar the two input images are at a basic pixel level. If the images are very similar at this stage, the test passes. This step can catch differences in color, fine details, and content. If this first check fails, the algorithm then looks specifically at the markup variation (markup variation identification). Markups could be things like highlighted text, lines or other markings, specific symbols on the screen, etc. In some embodiments, the markup variation identification involves several sub-steps. First, the images are converted into grayscale images and filtered to smooth the images and to remove noise. The algorithm tries to identify distinct objects (which could be markups) using a connected component algorithm. The connected component algorithm groups together connected pixels with similar properties. The algorithm then tries to find the edges around these potential markups using a key-point based algorithm. Key-point based algorithms are good at finding distinctive features like corners and edges. Finally, the algorithm compares the identified markups and their edges in both the expected and actual images to see if the differences are due to the markup being different or in a different place.

If the markup check also fails, the algorithm proceeds to check the overall layout (layout variation identification). The algorithm again uses a correlation coefficient algorithm, but this time it looks at different regions of the images to see if the layout of elements has changed. The algorithm ultimately gives an output of “passed” if the actual UI meets expectations or “failed” if there are discrepancies. The output can also indicate to the user why it failed, for example, due to color differences, markup issues, or layout problems. This helps developers quickly identify and fix any issues.

One advantageous aspect of the disclosed algorithm is that it's unsupervised. In the context of this disclosure for automated user interface testing, “unsupervised” means that the algorithm does not require any prior training or learning from labeled data to perform its task of comparing expected and actual UI screenshots. The algorithm is designed to work without needing to be shown numerous examples of “good” and “bad” UI screenshots beforehand to learn what to look for. This contrasts with “supervised” machine learning approaches that require large datasets to train a model. Similarly, unlike some automated testing methods that might rely on training datasets or specific rulesets, an unsupervised approach does not need extra data for training purposes. Because the disclosed algorithm is unsupervised, the algorithm can be applied to any pair of expected and actual UI screenshots without needing to be specifically trained for any particular application or any particular context. This makes the algorithm flexible and adaptable to different user interfaces and testing scenarios. In addition, the lack of reliance on training data makes the algorithm more efficient, because it skips the often time consuming and resource-intensive steps of data collection and model training. This approach also avoids the complexities of building and maintaining machine learning models.

Another advantage of the disclosed system is that the different parts of the algorithm can also be used separately to test for specific aspects like fine-grained details, color, markup, layout, content, etc. As outlined above, the unsupervised automated user interface testing algorithm can check five different aspects of the user interface. These aspects include fine-grained differences, color, markups, content, and layout.

Fine-grained differences are very subtle or granular visual variations, such as the difference between a rectangular and a cylindrical scroll bar, or between normal and bold text, for example. The algorithm may be configured to pass such minor differences. This is covered within the pixel variation identification block (discussed below). The algorithm checks for differences in color between the expected and actual user interface images. This is also part of the pixel variation identification step. The algorithm also verifies if the actual content (e.g., text, images, etc.) matches the expected content. This aspect is also covered under the pixel variation identification.

Markup refers to distinct visual elements or annotations on the UI, such as highlights, lines, arrows, or specific symbols. The algorithm checks if these are present and correctly located. This is specifically addressed in the markup variation identification step (discussed below). Layout variation identification involves checking the arrangement and positioning of different elements within the user interface. A difference in layout can cause the test to fail. The layout variation identification step (discussed below) specifically addresses this.

In some embodiments, these five aspects are checked by the algorithm in a specific order: first, pixel variation identification (which includes fine-grained, color, and content), then markup variation identification, and finally layout variation identification. If a test passes at an earlier stage, the subsequent checks might be skipped. The algorithm also offers flexibility to test each of these aspects separately. For example, a user tasked with testing UIs can selectively test individual aspects, as desired, rather than having the algorithm go through the entire process. For example, if a user wants to test specifically for fine-grained differences, color, markup, content, or layout, the user can choose to run the specific module or function within the algorithm designed for that purpose. For example, if a user knows they want to check only for markup variations, they can run just the “markup variation identification” part of the algorithm. A combined approach is also possible. A user can choose to let the algorithm run through its entire automated sequence of checks to see which aspect causes a failure. The user can then get a comprehensive understanding of the discrepancies. Alternatively, the user could stop the process after the first failure is detected and address that issue. This provides both an automated, sequential analysis and the flexibility for focused testing.

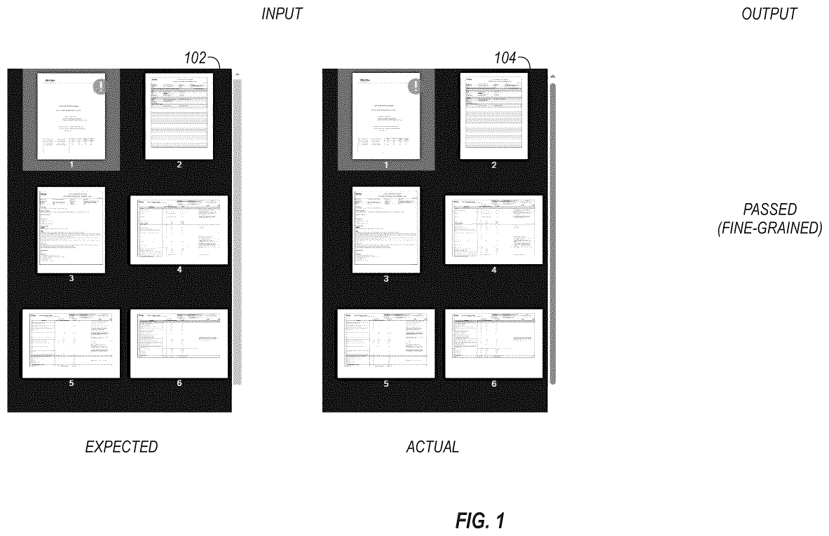

The unsupervised automated user interface testing algorithm described in detail below may be better understood by providing various examples of real-world exemplary UI tests conducted using the disclosed algorithm. FIGS. 1-8 are diagrams illustrating examples of expected and actual UI image inputs with various exemplary UI tests applied, and the results shown.

FIG. 1 illustrates an exemplary user interface test focusing on fine-grained visual differences. The expected UI screenshot 102 displays a user interface showing a number of thumbnails and has a rectangular scroll bar. In contrast, the actual UI screenshot 104, captured during testing, shows the same interface but with a rounded (cylindrical) scroll bar. Despite this visual deviation in the scroll bar's appearance, the result of the automated UI test is “passed”. This “passed” outcome signifies that the algorithm determined the difference between the rectangular and rounded scroll bars to be a minor, fine-grained variation that meets the defined expectations or thresholds for acceptance. This example highlights the algorithm's capability to identify and evaluate subtle visual differences and to classify them as acceptable based on predefined criteria, moving beyond simple pixel-level comparisons.

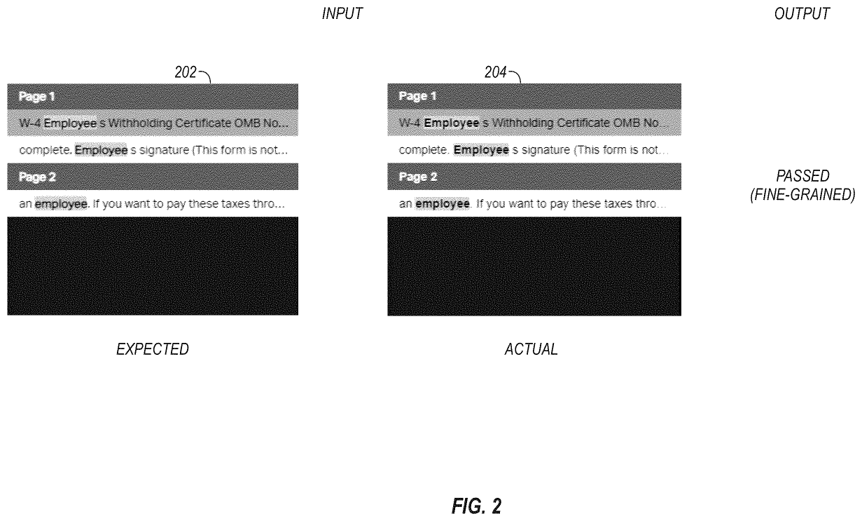

FIG. 2 depicts another exemplary user interface test focusing on fine-grained visual differences. The expected UI screenshot 202 displays a particular text element rendered in plain, normal text. However, the corresponding text element in the actual UI screenshot 204 is rendered in bold text. Despite this difference in text formatting, the result of the automated UI test is “passed”. This “passed” outcome indicates that the algorithm classified the variation between the plain and bold text as a minor, fine-grained discrepancy that is considered acceptable according to the defined criteria within the testing process. This illustrates the algorithm's ability to identify and evaluate subtle textual variations and to determine that such differences, in this case, do not constitute a failure.

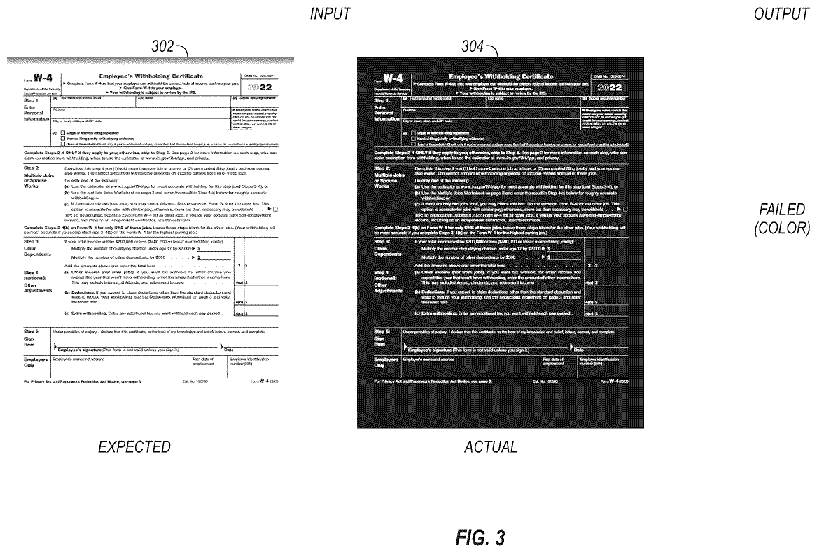

FIG. 3 illustrates an exemplary user interface test focusing on color variations. The expected UI screenshot 302 displays a user interface with a white background. In contrast, the actual UI screenshot 304, captured during testing, shows the same interface but with a dark background. This significant difference in the background color leads to a test result of “failed”. This “failed” outcome indicates that the algorithm detected a discrepancy in color that did not meet the defined expectations or thresholds for acceptance, signifying a notable visual bug that would require attention from developers. This example demonstrates the algorithm's capability to identify and flag substantial color deviations between the expected and actual user interfaces.

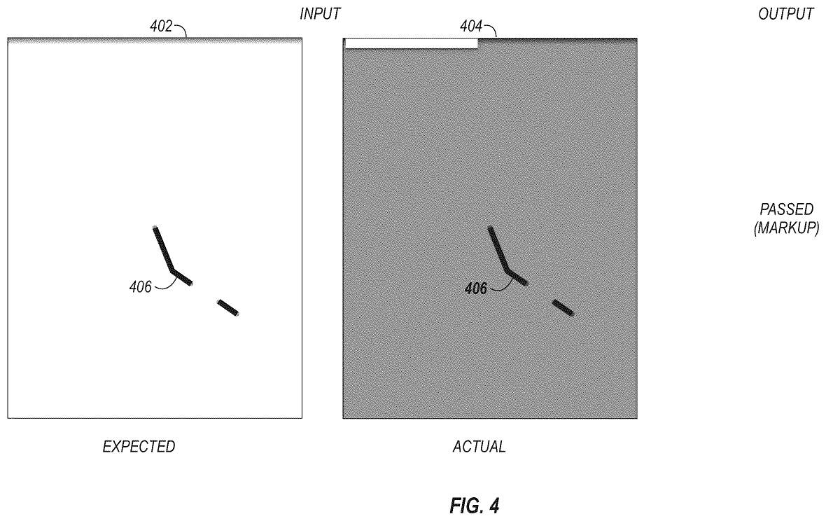

FIG. 4 illustrates an exemplary user interface test focusing on markup variation. The expected UI screenshot 402 displays a user interface with a white background and a particular markup 406 (in this example, a few lines). The actual UI screenshot 404 shows the same markup, meaning the underlying structure and elements of the user interface are identical to the expected, but it features a colored background instead of white. Despite the difference in background color, the result of the automated UI test is “passed”. This “passed” outcome signifies that the algorithm, when specifically testing the markup aspect, determined that the markup itself is consistent between the expected and actual UIs. The difference in background color, while potentially a pixel or color variation, does not constitute a failure when the focus of the test is solely on the markup. This demonstrates the algorithm's capability to isolate and compare the markup independently of other visual attributes like background color.

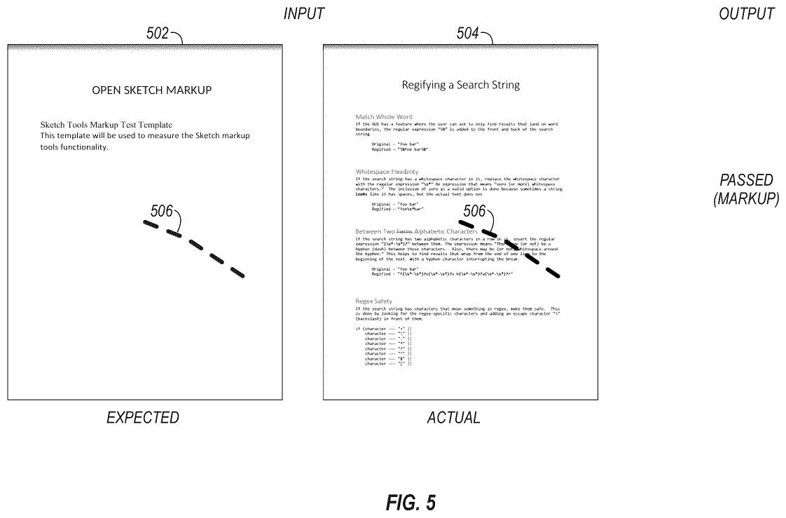

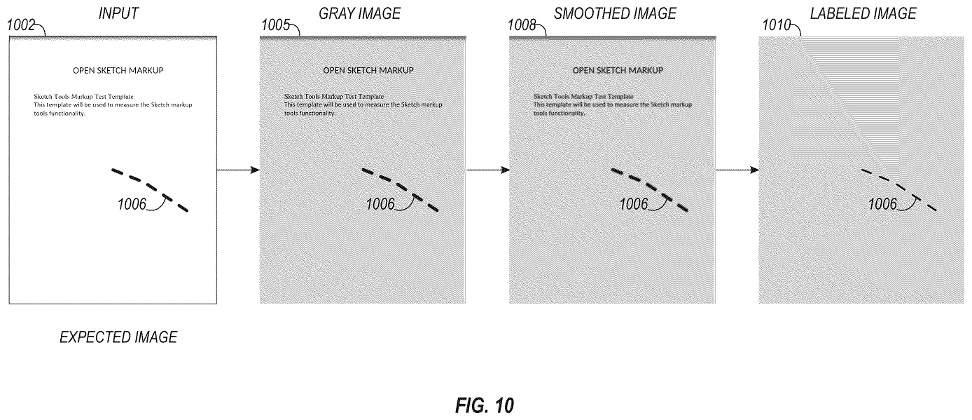

FIG. 5 illustrates an exemplary user interface test focusing on markup variation. The expected UI screenshot 502 displays a user interface with specific text content and a dashed line markup 506. The actual UI screenshot 504 shows a user interface with different text content compared to the expected image, but the dashed line markup remains the same. Despite the discrepancy in the text content, the result of the automated UI test is “passed”. This “passed” outcome indicates that the algorithm, when specifically testing the markup aspect, determined that the dashed line markup is consistent between the expected and actual UIs. The difference in text content, while a significant change in the user interface, is not considered a failure when the test is explicitly focused on verifying the integrity and consistency of the markup (in this case, the dashed line). This demonstrates the algorithm's ability to isolate and compare the markup structure, disregarding differences in content when the markup test is selected. Note that more details are provided about the markup variation identification process below, with respect to FIGS. 10-12.

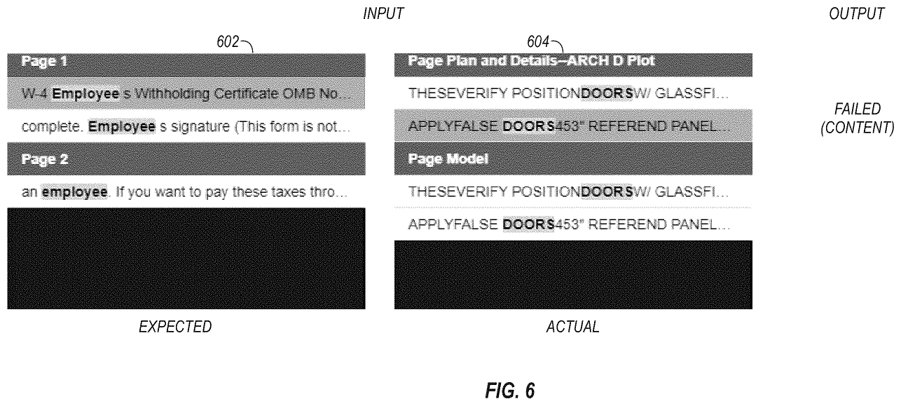

FIG. 6 illustrates an exemplary user interface test specifically examining content differences. The expected UI screenshot 602 displays a particular set of text content and specific page number indicators. In contrast, the actual UI screenshot 604, captured during testing, shows different text content and different page number indicators. This significant variation in the core textual information and navigational elements leads to a test result of “failed”. This “failed” outcome signifies that the algorithm, when focused on content comparison, detected substantial discrepancies between what was expected and what was actually rendered in the user interface. These differences in text and page numbers indicate a clear deviation from the expected content, necessitating review and correction.

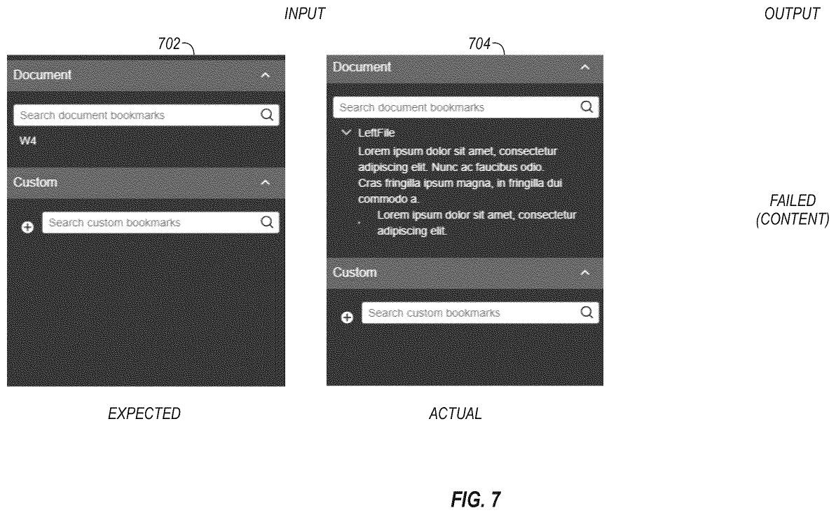

FIG. 7 illustrates an exemplary user interface test specifically examining content differences. The expected UI screenshot 702 displays a particular set of text content. In contrast, the actual UI screenshot 704, captured during testing, shows different text content. This significant variation in the core textual information leads to a test result of “failed”. This “failed” outcome signifies that the algorithm, when focused on content comparison, detected substantial discrepancies between the expected and actual text rendered in the user interface. These differences in content indicate a clear deviation from what was expected, necessitating review and correction. This example aligns with the algorithm's capability to identify and flag discrepancies in the textual information presented to the user.

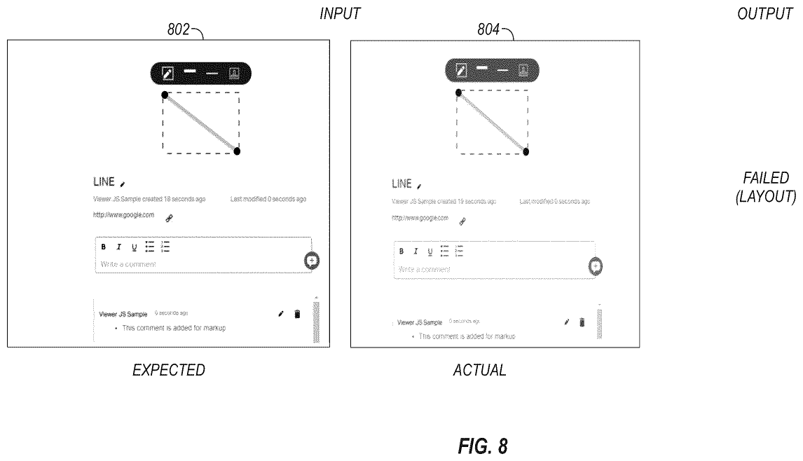

FIG. 8 illustrates an exemplary user interface test focusing on layout comparison. The expected UI screenshot 802 displays the content of the user interface in a specific arrangement and position. In contrast, the actual UI screenshot 804 shows the same content, but it is shifted upwards and to the left compared to its position in the expected screenshot. This difference in the spatial arrangement of the user interface elements leads to a test result of “failed”. This “failed” outcome indicates that the algorithm, when specifically testing the layout aspect, detected a significant discrepancy in the positioning of the UI elements. Even if the individual pixels, colors, markup, and content might be the same, the altered layout signifies a deviation from the expected presentation, indicating a potential visual bug or inconsistency that requires attention. The algorithm's ability to identify such regional pixel variations using a correlation coefficient algorithm allows it to flag layout issues.

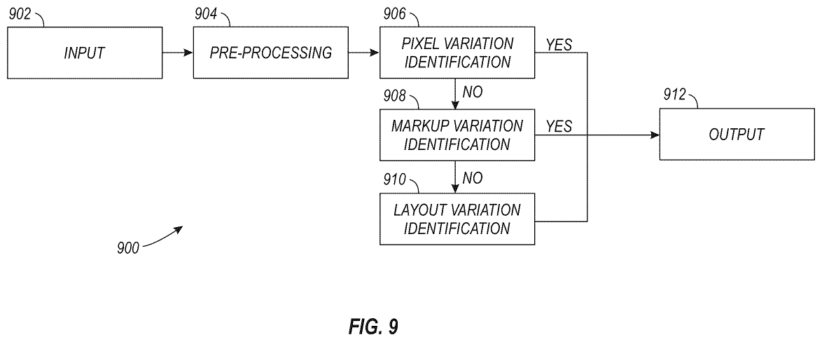

Referring again to the specifics of the disclosed algorithm, FIG. 9 is a block diagram illustrating an exemplary operation for an automated user interface testing system. FIG. 9 shows an algorithm 900, as outlined above. An input block 902 represents a captured UI screenshot (actual) (e.g., screenshots 104, 204, . . . 804 in FIGS. 1-8) and an expected UI screenshot (e.g., screenshots 102, 202, . . . 802 in FIGS. 1-8). As discussed above, the algorithm takes these two input images as its primary input for comparison.

The pre-processing step 904 involves preparing the input images for subsequent analysis. In some embodiments, the pre-processing includes scaling the images while maintaining the aspect ratios. This ensures that images of different sizes can be compared effectively without distortion. The pre-processing step 904 also involves normalization. Normalization may involve adjusting the pixel intensity values to a standard range, which can help in making the comparison more robust to variations in brightness and contrast.

The pixel variation identification step 906 is the first stage of the core comparison process. This step aims to identify overall pixel-level differences between the expected and actual images. The pixel variation identification step 906 covers several aspects. First, it uses a correlation coefficient algorithm to identify the overall pixel variation in the entire given input images. The correlation coefficient measures the similarity between the pixel intensity values of the two images. A high correlation indicates similarity, while a low correlation suggests dissimilarity. The pixel variation identification step 906 covers the aspects of color, fine-grained differences, and content variations described above. The algorithm checks for subtle visual discrepancies (fine-grained), changes in color, and differences in the actual content displayed. If the pixel variation is significant enough to fail a predefined threshold (note that the threshold setting can be determined by the algorithm designer), the process moves to the next block (markup variation identification block 908) to determine the cause of the failure. If the pixel variation is within an acceptable range, the output will be “passed”.

The markup variation identification block 908 is engaged if the pixel variation identification step 906 does not result in a “pass” and the algorithm proceeds to investigate if the failure is due to differences in markup. This is a more complex process involving several sub-steps. In some embodiments, an 8-bit grayscale image is generated from both the expected and actual images. This step simplifies the images by removing color information, focusing on intensity values. Next, the grayscale image is smoothed by applying a Gaussian filter. This helps to remove smaller objects and noise, potentially isolating the larger markup elements.

Next, a connected component algorithm is used for identifying objects in the images. Generally, a connected component algorithm is used to identify and label groups of connected pixels in an image. This algorithm groups pixels that are connected and share similar intensity, helping to identify distinct visual components, which could be markup.

Next, a labeled image is generated based on the identified objects and a threshold value. Each identified connected component (potential markup) is assigned a unique label. By applying a correlation coefficient algorithm on the labeled images, a matching score is generated. The matching score assesses the similarity of the identified markup regions in both images.

Next in the process is generating another grayscale image and identifying the edges around the markup using a key-point based algorithm. A key-point based algorithm detects distinctive features like corners and edges that are invariant to certain transformations. Examples of such algorithms include SIFT, SURF, and ORB. Identifying the number of matching edges between the expected and actual images is then performed using a KNN (K-Nearest Neighbors) matching algorithm and a distance ratio test. This step compares the key points found in both images to see how well they correspond.

Finally, the matching score (from the correlation coefficient on labeled images) and the matching edges are combined to determine if the markup is considered a pass or fail. This combined analysis helps to account for cases where the markup might be present but in a slightly different location. More details regarding markup variation identification are provided below with respect to FIGS. 10-12.

The layout variation identification block 910 is the final stage in the automated sequence if the preceding pixel and markup variation checks did not result in a “pass.” The layout variation identification block 910 focuses on the overall arrangement and positioning of elements in the user interface. This process identifies the regional pixel variation by using a correlation coefficient algorithm. In some embodiments, instead of comparing the entire image at once, this step divides the images into regions and compares the correlation within corresponding regions to detect layout shifts or changes in the arrangement of larger elements. If significant layout variations are detected, the output will indicate a “fail” due to layout discrepancies.

The output block 912 is the final result of the algorithm's analysis. In some embodiments, the output is a string value indicating whether the actual screenshot passed (meets expectation) or failed (discrepancies exist). If the algorithm identifies a specific type of failure (e.g., color, markup, layout), this information can also be conveyed, providing more detailed feedback to the user. The user can also choose to get the output for specific aspects if they run individual modules of the algorithm.

Referring again to the markup variation identification block 908, FIGS. 10-12 provide more details relating to generating the labeled images and matching edges. FIG. 10 is a diagram showing a process of generating a labeled image from an expected input image (note that this is the same expected screenshot image 502 shown in FIG. 5). In this example, image 1002 includes some text, as well as markup 1006. As discussed above, the expected image 1002 is used to generate an 8-bit gray-scale image 1005. Next, the grayscale image 1005 is smoothed by applying a Gaussian filter, resulting in smoothed image 1008. Finally, the image is labeled, resulting in labeled image 1010. Objects that are not required (e.g., the text) are omitted.

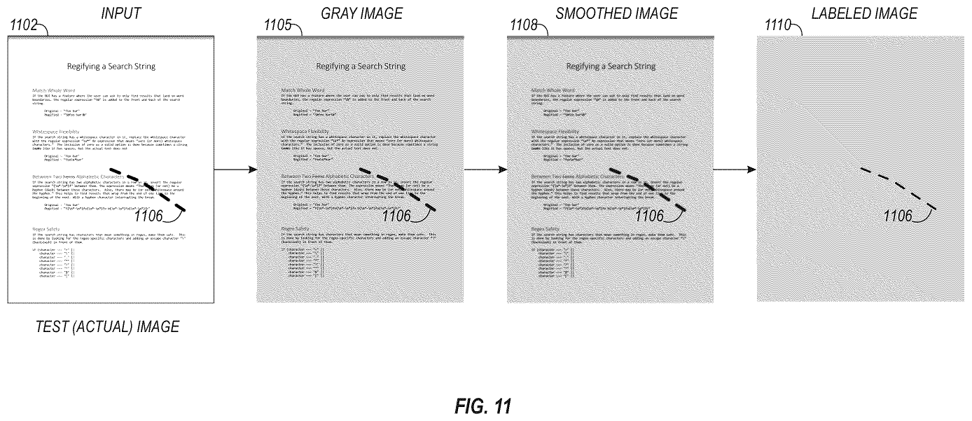

FIG. 11 is similar to FIG. 10, but shows the process for test (actual) image 1102. Like FIG. 10, FIG. 11 shows a process of generating a labeled image from the test image 1102 (note that this is the same expected screenshot image 504 shown in FIG. 5). In this example, image 1102 includes some text (different from the image 1002) , as well as markup 1106. As discussed above, the test image 1102 is used to generate an 8-bit gray-scale image 1105. Next, the grayscale image 1105 is smoothed by applying a Gaussian filter, resulting in smoothed image 1108. Finally, the image is labeled, resulting in labeled image 1110. Objects that are not required (e.g., the text) are omitted. Now, both images 1010 and 1110, only the markup 1006/1106 remains. From there, the correlation coefficient algorithm is used to see if the markups 1006 and 1106 match or not.

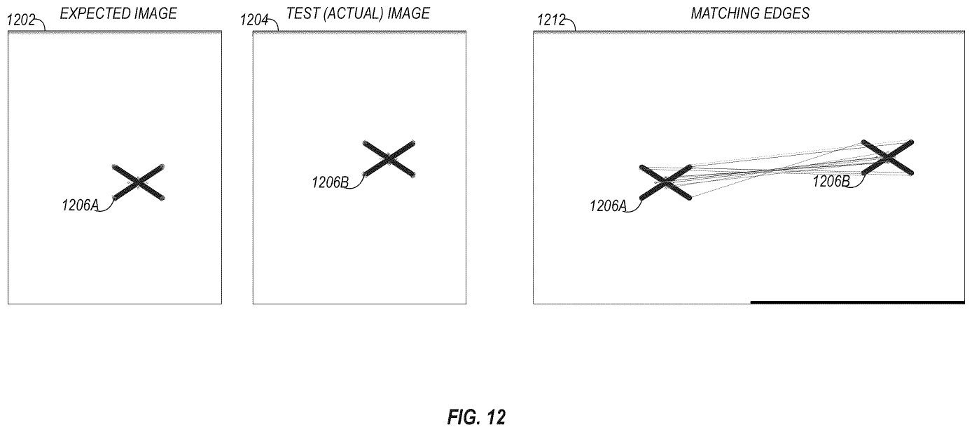

FIG. 12 illustrates another part of the markup variation process. In some examples, a markup itself can match, but be located in a different place on the image. FIG. 12 shows an expected image 1202 and a test (actual) image 1204, each having a markup 1206A and 1206B, respectively. As shown, the markup 1206B of test image 1204 is positioned slightly upward, compared the markup 1206A of expected image 1202. The process attempts to find if there are matching edges of the markups 1206A and 1206B. View 1212 illustrates the matched edges of the markups 1206A and 1206B. As discussed above, a key-point algorithm can be used to identify the edges around markups. Then, a KNN matching algorithm and distance ratio test can be used to identify the number of matching edges. In this example, the UI test passes, since the edges match.

Several advantages of the disclosed unsupervised automated user interface testing are discussed above, for example, advantages relating to the unsupervised natures of the algorithm used. As discussed, the invention has the technical advantage of the prior art (e.g., over ML based systems) of being more efficient, less costly, and will use less computational resources. As discussed, the unsupervised automated user interface testing system is more efficient than a system using ML models because it skips the training and data collection processes that are required by ML models. Similarly, the disclosed algorithm can run on lower end machines, without the need for GPU's or other high end computer hardware. Another technical improvement is evident by contrasting the invention with prior solutions that only check for pixel variations and thus have a high false positive or negative rates. The disclosed systems make process more useful and efficient by checking other aspects, like markup and layout, thereby potentially reducing the number of iterations needed to fix issues and speeding up the development process, thus reducing costs and reducing burdens on computer systems.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method for unsupervised user interface testing, comprising:
receiving an input image, the input image comprising a screenshot of a user interface (UI) output being tested;
pre-processing the input image by scaling and normalizing the input image;
identifying a degree of pixel variation between the input image and an expected UI output image using a correlation coefficient algorithm that generates a pixel variation score relating to a degree of pixel variation between the input image and the expected UI output image;
generating a pass or fail result of the identified pixel variation based on the pixel variation matching score;
responsive to a failed result of identified pixel variation, performing a markup variation identification between the input image and the expected UI output image to identify a markup and to determine a markup variation score relating to a degree of markup variation between the input image and the expected UI output image;
responsive to a failed result of markup variation, performing a layout variation identification between the input image and the expected UI output image using a second correlation coefficient algorithm that generates a layout variation score relating to a degree of layout variation between the input image and the expected UI output image; and
outputting a test result indicating whether the input image meets expectations.

2. The method of claim 1, wherein the markup variation identification further comprises:
generating a matching score by applying a correlation coefficient algorithm to a labeled image based on identified objects in the input image and the expected UI output image;
identifying matching edges of markups identified in the input image and the expected UI output image; and
wherein the markup variation score is determined by combining the matching score and the matching edges.

3. The method of claim 2, wherein generating the matching score further comprises:
generating a gray-scale image from the input image;
filtering the gray-scale image to remove noise;
wherein the objects identified in the image are identified using a connected component algorithm; and
wherein the generating labeled image is generated based on the identified objects in the image and a threshold value.

4. The method of claim 3, wherein identifying matching edges further comprises Identifying edges around the identified markup in the input image and the expected UI output image.

5. The method of claim 4, wherein the edges are identified using a matching algorithm.

6. The method of claim 3, wherein the generated gray-scale image is an 8-bit gray-scale image.

7. The method of claim 3, wherein the gray-scale image is filtered using a Gaussian filter.

8. A system for providing unsupervised user interface testing, the system comprising:
a processor; and
a non-transitory computer readable medium storing instructions translatable by the processor, the instructions when translated by the processor perform:
receiving an input image, the input image comprising a screenshot of a user interface (UI) output being tested;
pre-processing the input image by scaling and normalizing the input image;
identifying a degree of pixel variation between the input image and an expected UI output image using a correlation coefficient algorithm that generates a pixel variation score relating to a degree of pixel variation between the input image and the expected UI output image;
generating a pass or fail result of the identified pixel variation based on the pixel variation matching score;
responsive to a failed result of identified pixel variation, performing a markup variation identification between the input image and the expected UI output image to identify a markup and to determine a markup variation score relating to a degree of markup variation between the input image and the expected UI output image;
responsive to a failed result of markup variation, performing a layout variation identification between the input image and the expected UI output image using a second correlation coefficient algorithm that generates a layout variation score relating to a degree of layout variation between the input image and the expected UI output image; and
outputting a test result indicating whether the input image meets expectations.

9. The system of claim 8, wherein the markup variation identification further comprises:
generating a matching score by applying a correlation coefficient algorithm to a labeled image based on identified objects in the input image and the expected UI output image;
identifying matching edges of markups identified in the input image and the expected UI output image; and
wherein the markup variation score is determined by combining the matching score and the matching edges.

10. The system of claim 9, wherein generating the matching score further comprises:
generating a gray-scale image from the input image;
filtering the gray-scale image to remove noise;
wherein the objects identified in the image are identified using a connected component algorithm; and
wherein the generating labeled image is generated based on the identified objects in the image and a threshold value.

11. The system of claim 10, wherein identifying matching edges further comprises Identifying edges around the identified markup in the input image and the expected UI output image.

12. The system of claim 11, wherein the edges are identified using a matching algorithm.

13. The system of claim 10, wherein the generated gray-scale image is an 8-bit gray-scale image.

14. The system of claim 10, wherein the gray-scale image is filtered using a Gaussian filter.

15. A computer program product comprising a non-transitory computer readable medium storing instructions translatable by a processor, the instructions when translated by the processor perform, in an enterprise computing network environment:
receiving an input image, the input image comprising a screenshot of a user interface (UI) output being tested;
pre-processing the input image by scaling and normalizing the input image;
identifying a degree of pixel variation between the input image and an expected UI output image using a correlation coefficient algorithm that generates a pixel variation score relating to a degree of pixel variation between the input image and the expected UI output image;
generating a pass or fail result of the identified pixel variation based on the pixel variation matching score;
responsive to a failed result of identified pixel variation, performing a markup variation identification between the input image and the expected UI output image to identify a markup and to determine a markup variation score relating to a degree of markup variation between the input image and the expected UI output image;
responsive to a failed result of markup variation, performing a layout variation identification between the input image and the expected UI output image using a second correlation coefficient algorithm that generates a layout variation score relating to a degree of layout variation between the input image and the expected UI output image; and
outputting a test result indicating whether the input image meets expectations.

16. The computer program product of claim 15, wherein the markup variation identification further comprises:
generating a matching score by applying a correlation coefficient algorithm to a labeled image based on identified objects in the input image and the expected UI output image;
identifying matching edges of markups identified in the input image and the expected UI output image; and
wherein the markup variation score is determined by combining the matching score and the matching edges.

17. The computer program product of claim 16, wherein generating the matching score further comprises:
generating a gray-scale image from the input image;
filtering the gray-scale image to remove noise;
wherein the objects identified in the image are identified using a connected component algorithm; and
wherein the generating labeled image is generated based on the identified objects in the image and a threshold value.

18. The computer program product of claim 17, wherein identifying matching edges further comprises Identifying edges around the identified markup in the input image and the expected UI output image.

19. The computer program product of claim 18, wherein the edges are identified using a matching algorithm.

20. The computer program product of claim 17, wherein the generated gray-scale image is an 8-bit gray-scale image.
